(19) United States
(12) Patent Application Publication
(10) Pub. No.: US 2019/0023479 A1
(43) Pub. Date: Jan. 24, 2019

(54) SYSTEM AND METHODS FOR PRODUCING COOKED DISPENSABLE PACKAGED CHUNKY FOOD

(71) Applicant: Freeli Foods LLC, Piedmont, CA (US)

(72) Inventors: Matthew Sade, Oakland, CA (US); Stephanie Brendel, Piedmont, CA (US); Matthew Tom, San Jose, CA (US)

(21) Appl. No.: 16/038,782

(22) Filed: Jul. 18, 2018

Related U.S. Application Data
(60) Provisional application No. 62/535,195, filed on Jul. 20, 2017.

(51) Int. Cl. B65D 81/34; B65D 75/58; A23L 3/01

(52) U.S. Cl. CPC B65D 81/3461; B65D 75/5805; A23V 2002/00; B65D 2581/3402; B65D 2205/02; A23L 3/01

(57) ABSTRACT

Provided are systems and methods for producing, packaging and dispensing cooked chunky food that may be a low acid, high water activity food having high organoleptic (e.g., flavor, texture, aroma, color, etc.), and nutritive (vitamins, nutrients, etc.) quality, and an extended refrigerated shelf-life relative to prior art refrigerated prepared foods. Example methods combine hot-filling (e.g., into microwavable self-venting hand-held pouches) immediately after cooking using low-shear transfer at suitable transfer temperature and rate through a fill/dispensing portion sized to provide for substantially unimpeded flow without textural degradation of the chunky food, followed by immediate post-fill chilling and storage under refrigerated and/or frozen conditions. Also provided are chunky foods produced by the methods, and packaging containers (e.g., microwavable self-venting hand-held pouches) suitable for easy, mess-free directed dispensing of the packaged chunky food composition from the pouch by hand, including by children, or adults.

### FIELD OF THE INVENTION

The following description relates to packaged food products that contain a cooked, chunky food composition, wherein the package allows for the food composition to be heated and then dispensed through a dispensing portion of the package by hand, by a user, directly to the mouth of the user for consumption. In certain exemplary aspects, the invention relate to methods for producing, packaging, storing and dispensing packaged chunky food (e.g., meals) of high organoleptic quality, and in more particular aspects to food-safe methods for producing, packaging and dispensing non-retort cooked chunky, low acid, high water activity, refrigerated, prepared foods exhibiting high organoleptic (e.g., flavor, texture, aroma, color, etc.), nutritive (vitamins, nutrients, etc.) quality, and optionally with an extended shelf-life relative to other common refrigerated prepared foods. Additional exemplary aspects of the invention relate to the packaged chunky food products produced by the methods, to packaging containers (e.g., self-venting containers, pouches, etc.) suitable for easy dispensing the packaged chunky food (e.g., by hand from a pouch, including by a child or elderly adult), and to methods of consuming the packaged food by directly dispensing the chunky food to a mouth of a user.

### BACKGROUND

Currently, the art for providing conveniently dispensable foods (e.g., pouch-dispensable foods) is dominated by foods for babies, toddlers, and kids, such as baby foods, yogurt (not containing large particulates), oatmeal, and applesauce and similar fruit or vegetable purees. The range of food choices available in pouch-dispensable foods can be considered rather limited. Consumers do not presently have a broader range of food options in conveniently-packaged, hand-dispensable foods, which would be desirable.

In specific, consumers do not presently have choices of higher-caloric hand-dispensable foods that would satisfy older kids and adults as a snack, or even as a meal or a substantial portion of a meal. Older children and adults may not find pureed foods very desirable, especially if the food has been processed and degraded by exposure to high temperatures during cooking, pasteurization, sterilization, or the like. Older children and adults typically prefer chunky-style foods as a meal or a snack. Examples of these types of foods that appeal to older kids and adults include: macaroni and cheese, noodles, spaghetti, egg-based entrees, stews, and the like, any of which may include rice, beans, or chunks of meat or vegetables to increase the nutritive or caloric value of the food composition. While some current commercial hand-dispensable foods may contain small particles such as seeds or small pieces of oatmeal, there is a need for hand-dispensable food products that contain larger pieces of food associated with higher-caloric foods.

Pouch-dispensable foods such as baby foods and applesauce are often cooked, processed, and packaged to be stable for an extended storage period at non-refrigerated conditions. The packaged foods are often retort-cooked to provide for safety and extended ambient shelf stability. But, while retort-cooked foods have good stability, the retort-cooking process can negatively affect the organoleptic and nutritive quality of a cooked food.

In a retort cooking process, a food is placed into a retort container (e.g., a non-microwavable, retort pouch constructed from flexible film metal-plastic laminate that is not permeable to gas and is able to withstand high heat thermal processing), sealed in the retort container, and cooked for a sufficient time, at high temperature (e.g., 240-250° F. (116-121° C.)) and under high pressure inside a retort machine to kill microorganisms. The high cooking temperatures involved, in combination with the non-gas permeable retort pouch laminate structure, provides for a sterile (destroys spoilage- and disease-causing bacteria and spore formers) product with a long shelf-life, even at ambient temperature, which is highly commercially desirable. The slow heat transfer to the center of a container, however, results in overcooking of the food, loss of texture, destruction of vitamins and pigments, and undesirable browning and off flavors. The organoleptic (e.g., texture, flavor, aroma, nutrients, color etc.) and nutritive (vitamins, nutrients, etc.) qualities of the retort cooked food are degraded by such high heat cooking, and retort processed foods do not typically provide the culinary and nutritive experience of a traditional chunky meal.

Other methods that are different from retort cooking are also known and useful for processing a food product to kill microorganisms to increase the shelf-stability of a packaged food product. Examples include “low temperature” or “cold” pasteurization, ultra-high temperature (UHT) processing, and “flash pasteurization.” Ultra-high temperature processing may be used in a larger method of aseptic packaging, by which a food and a package are separately sterilized, the sterilized food is placed in the sterilized package, and the package is sealed, all within a sterile environment. Methods of aseptic packaging using ultra-high temperatures (UHT) can provide fast convective heat transfer in a heat exchanger, or use of steam injection to reduce process time with minimal come-up and cool-down time, which can lead to higher-quality product and improved nutritional contents relative to retort methods. But, UHT processing may be challenging to apply to certain types of foods, such as “chunky” foods, because of the possibility of overcooking surfaces of larger food particulates, lack of equipment for particulate sterilization due to settling of solids, and the difficulties of determining particle residence time distribution (RTD) because of varying particle size.

Unprocessed foods, including foods that are not processed by a step to kill microorganisms, typically require additional handling/preparation steps and have much shorter shelf lives compared to foods that have undergone a step of killing microorganisms.

There is, therefore, a general need for easily consumed, e.g., hand-dispensable or pouch-dispensable, packaged cooked food products for children (all ages) and adults that contain cooked food compositions adapted as a snack food, a meal, or a portion of a meal, e.g., “chunky” foods that are more appealing to older children and to adults than are the few types of pouch-dispensable foods presently available, which are substantially limited to baby foods, applesauce, and other pureed fruits and vegetables, and which are typically processed by a retort-cooking step or another high temperature food processing step that causes degradation of the organoleptic and nutritive properties of the food.

### SUMMARY OF THE INVENTION

The present disclosure satisfies these and other needs relating to high quality dispensable foods that are chunky, non-retort-cooked, or both chunky and non-retort-cooked.

The Applicant has identified new and inventive packaged food products that include a chunky cooked food composition contained in a hand-holdable package from which the chunky cooked food composition can be easily dispensed, particularly, by hand-dispensing the chunky food composition from a dispensing portion of the package directly to a mouth of consumer. The chunky cooked food composition can be sterilized, pasteurized, UHT treated, retort cooked, or the like, to kill microorganisms to increase a shelf-life of the food composition, and optionally packaged by aseptic packaging steps. If so, the packaged food product may have an extended shelf-life, even at non-refrigerated, e.g., ambient, conditions. Alternately, the chunky food composition may be cooked using a non-retort cooking method and not subsequently sterilized or pasteurized. If so, the packaged food product may have relatively short shelf-life at non-refrigerated, e.g., ambient, conditions, but can have a commercially acceptable shelf-life when stored with refrigeration (e.g., from 34 to 50 degrees Fahrenheit) or by freezing (e.g., at below 32 degrees Fahrenheit, e.g., at a temperature in a range from −10 degrees Fahrenheit to 0 degrees Fahrenheit).

The packaged food product can be heated, for example in a microwave oven, to heat the contained food composition before the food composition is consumed. The package may optionally be designed to specifically allow for the package to be heated by use of a microwave oven.

The package includes a dispensing portion, which is a portion of the package that includes an opening or that is adapted to create an opening in the package that allows for the chunky food composition to be dispensed from the package, and is also capable of being used in a way by which the user directs the flow of the food composition out of the package as the food composition flows from the package. The dispensing portion can be used to dispense the chunky food composition from the interior of the package, through the dispensing portion, and directly into a mouth of a user (consumer), for eating the chunky food composition directly from the package. Example dispensing portions can be in the form of an opening that is present on the package or that can be formed on the package, e.g., at a corner, by removing, tearing, or cutting a portion of the package. Alternate dispensing portions may include a plastic piece (e.g., “fitment”) that includes a channel, aperture, spout, funnel, tube, or other type of a flow duct, conduit, or passage through which the cooked chunky food composition can be dispensed; a removable cover, closure, or cap, may be used to reversibly open and close (cover and uncover) the fitment, and may include a snap-on, screw-on, or other releasable and re-closeable fastening mechanism.

The chunky food composition can be manually caused to flow from the interior of the package, through the dispensing portion, to an exterior of the package, e.g., directly into a mouth of a user. Dispensing the chunky food composition in this manner can be performed by placing pressure on the flexible package, e.g., by hand or by suction (negative internal pressure), to cause the chunky food contents of the package to flow out of the dispensing portion. The dispensing portion has an aperture or “opening” that is large enough to allow the chunky food composition to easily flow through the dispensing portion, but that is also of a size that allows a user to direct the flow of the chunky food composition as the chunky food composition flows out of the package. Because the food composition is chunky, the opening can be larger than would be necessary for dispensing a non-chunky food composition such as applesauce, non-particulate-containing yogurt, or a puree (e.g., baby food).

The dispensing portion differs from other types of openings in various types of packages, for example an opening along a length of an edge or across a surface of another type of package from which a food may be poured (even if into a mouth), or from which a food may be removed by use of a fork, spoon, or other utensil, or by hand. To use a dispensing portion of a package as described, a user may hold the package in any of an upright, tilted, or inverted position, and by applying exterior pressure on the sides of the package, or suction at the interior of the package, may cause the food composition to flow from the package interior, through the dispensing portion, and preferably direct the flow of the food composition to a desired target such as directly into a user's mouth.

Example packaged food products are described as follows, with an emphasis on non-retort-cooked, microwaveable, packaged food compositions that may exhibit improved organoleptic or nutritional properties, that may be stored and presented for sale with refrigeration, and that may preferably be free of artificial preservatives.

It is to be recognized, however, that the present description is not limited to any particular method of preparing a chunky food composition (i.e., not limited to non-retort cooking methods), is not limited to any particular feature of composition (i.e., is not limited to foods that do not contain a preservative), and is also not limited to any specific organoleptic or compositional properties of the chunky food composition.

In certain presently-preferred example packaged food products, the chunky food composition may be non-retort cooked to prevent degradation of the food composition that may occur at high temperatures associated with a retort cooking step. The non-retort cooked food composition may also, optionally, be non-sterilized and non-pasteurized, also to avoid exposure of the chunky food product to elevated temperatures that may cause undesired degradation of the chunky food composition and loss of flavor, color, texture, nutritive value, or other organoleptic properties. The packaged food product that contains this non-retort cooked food composition may preferably be in a flexible, pouch-type package that includes a dispensing portion having an opening with a minimum diameter of at least 10, 12, or 14 millimeters, or larger, for direct dispensing to a user's mouth, and may be capable of being heated in a microwave oven, preferably by being self-venting and by excluding any packaging layer that contains a metal layer or metal coating. The type of food may be a chunky food, meaning not a baby food, not yogurt (that does not contain particles), and not applesauce or a similar fruit or vegetable puree. The chunky food may for example contain particles of pasta (e.g., macaroni and cheese, or another type of noodle or spaghetti); egg particles; beans; tofu; fruit chunks; or chunks of vegetable, meat, or other high protein particles. The packaged non-retort cooked food product may also contain particles of oats, e.g., as oatmeal, either in combination with other chunky food particles (e.g., pieces of fruit), or without other chunky food particles. The packaged food may be stored or presented for sale using refrigerated or frozen storage.

In other embodiments, if desired, the chunky food product may be sterilized, pasteurized, cooked by a retort cooking method, or otherwise processed to kill microorganisms, even if in a manner that may (while not preferred) have a negative effect on nutritive, organoleptic, flavor, or color qualities of the food composition. The cooked (e.g., retort-cooked or otherwise sterilized) chunky food composition may preferably be contained in a flexible, pouch-type package that includes a dispensing portion having an opening with a minimum diameter of at least 10, 12, or 14 millimeters, or larger, for direct dispensing of the cooked chunky food product to a user's mouth, and may be capable of being heated in a microwave oven, preferably by being self-venting and by excluding any packaging layer that contains a metal layer or metal coating. The type of food may be a chunky food, meaning not a baby food, not yogurt (that does not contain particles), and not applesauce or a similar fruit or vegetable puree. The chunky food may for example contain particles of pasta (e.g., macaroni and cheese or another type of noodle or spaghetti); egg particles; beans; tofu; fruit chunks; or chunks of vegetable, meat, or other high protein-content particles. The packaged cooked chunky food product, which may be retort cooked or otherwise sterilized, may also contain particles of oats, e.g., as oatmeal, either in combination with other chunky food particles (e.g., pieces of fruit), or without other chunky food particles. The packaged food may be stored or presented for sale using refrigerated or frozen storage.

In specific example embodiments there is a need in the art for methods of producing savory, wholesome and conveniently dispensable (e.g., non-retort cooked) chunky, low acid, high water activity meals (e.g., chicken, beef, vegetables, rice, etc.) that may preferably retain their natural chunky organoleptic and nutritive qualities, have extended refrigerated shelf-life, are microwavable, and provide for ease of consumption, including by children and older adults.

Particular aspects provide a hand-dispensable non-retort cooked and packaged chunky food composition having improved organoleptic and nutritional qualities, comprising: a non-retort cooked chunky food composition having sized chunky food pieces that account for a mass percentage in the range of 5% to 95% of the food composition to provide a chunky textured food composition; packaged within a hand-holdable, microwaveable, self-venting flexible-film pouch having a dispensing portion sized and configured to provide for substantially unimpeded flow of the sized chunky food composition during hand-mediated dispensing thereof from the pouch through the dispensing portion. The shelf-life of the hand-dispensable non-retort cooked and packaged chunky food is, for example, a time period selected from the group consisting of: at least 7, 14, 30, or 60 days, at least 90 days, at least 120 days, at least 150 days, at least 180 days, at least 230 days, at least 360 days, and greater periods, in each case at a storage temperature value in a range of about 1° C. to about 4.4° C. (about 34° F. to about 40° F.), or frozen. The pouch and the dispending portion are configured (e.g., internally shaped) to provide for directed flow of the non-retort cooked packaged chunky food during hand-mediated dispensing thereof.

The chunky food pieces of the hand-dispensable cooked and packaged chunky food may, for example, have a size dimension: in a range of 3 mm to 19 mm (⅛ to ¾ inch) (alternatively at least 4, 5, 8, or 9 millimeters) and account for a mass percentage in the range of 10% to 90% (e.g., at least 15%, at least 20%, at least 30%, at least 40%, or at least 50%) of the food composition; in a range of 6 mm to 16 mm (¼ to ⅝ inch) and account for a mass percentage in the range of 10% to 90% (e.g., at least 15%, at least 20%, at least 30%, at least 40%, or at least 50%) of the food composition; in a range of 10 mm to 13 mm (⅜ to ½ inch) and account for a mass percentage in the range of 10% to 90% (e.g., at least 15%, at least 20%, at least 30%, at least 40%, or at least 50%) of the food composition; or any size and/or mass percentage subranges within the preceding ranges.

Some specific examples of foods that are considered to be “chunky” are foods that include one or more of the following types of foods, containing particles of at least 3 millimeters in one dimension: macaroni and cheese and other noodles, pasta, or spaghetti; egg-based entrees; stews, and the like, any of which may include particles of rice, beans, or chunks of meat (beef, poultry, pork), fish, or vegetables to increase the nutritive or caloric value of the food composition. The food may be relatively high in protein with certain (non-limiting) example chunky food compositions having a protein content that is greater than that of a fruit or vegetable puree such as applesauce or baby food, that is greater than yogurt, or that is greater than oatmeal. Example chunky food compositions may include particles that are high in protein, such as particles of meat (e.g., chicken, beef, or pork) or fish; these may be foods such as stews, soups, spaghetti and meatballs, a “hot dish,” or other foods that are higher in calorie content and protein as compared to baby food, other purees, oatmeal, and applesauce.

Oatmeal may be considered a “chunky” food if an oatmeal contains pieces of oat that have at least one dimension that exceeds 3, 4, 5, or 6 millimeters.

Regardless of particles size, oatmeal may be included in products and methods of the present invention if an oatmeal is otherwise prepared or consumed as described herein. One example of a packaged food product of the present description that contains oats or oatmeal as an ingredient of a cooked chunky food composition includes a chunky food product processed by a non-retort method, and preferably where the package is: a flexible, pouch-type package that includes a dispensing portion having an opening with a minimum diameter of at least 10, 12, or 14 millimeters, or larger, for direct dispensing to a user's mouth and is capable of being heated in a microwave oven, preferably by being self-venting and by excluding any packaging layer that contains a metal layer or metal coating. The packaged food may be stored or presented for sale using refrigerated or frozen storage.

Another example packaged food product of the present description that contains oats or oatmeal as an ingredient of a cooked chunky food composition includes a chunky food product that may be processed (e.g., cooked) by a retort method or other method that produces a sterilized food product, where the package is: a flexible, pouch-type package that includes a dispensing portion having an opening with a minimum diameter of at least 10, 12, or 14 millimeters, or larger, for direct dispensing to a user's mouth and is capable of being heated in a microwave oven, preferably by being self-venting and by excluding any packaging layer that contains a metal layer or metal coating. The packaged food may be stored or presented for sale using refrigerated or frozen storage.

The non-retort cooked chunky food composition may, for example, be cooked under non-retort conditions at a temperature in a range of: 74° C.-90.6° C. (165° F.-195° F.); 74° C.-93.3° C. (165° F.-200° F.); or less than 93.3° C. (less than 200° F.) to substantially reduce or prevent heat-induced degradation of at least one of flavor, color, texture, aroma or vitamins/nutrients. After cooking and packaging, the non-retort cooked chunky food composition may, for example, be refrigerated at a temperature value in a range of about 1° C. to about 4.4° C. (about 34° F. to about 40° F.). The hand-dispensable non-retort cooked and packaged chunky food may, for example, comprise no added preservatives, or may, for example, comprises only naturally-occurring preservatives, or safe food preservatives. The hand dispensable non-retort cooked and packaged chunky food composition may, for example, provide a full caloric density of a main meal course or entree.

The dispensing portion of the hand-dispensable cooked and packaged chunky food product may comprise, for example, a tear-open spout or a fitment, to provide an opening or diameter in a size range of: at least 10, 12, or 14 mm to 35 mm; 16 mm to 30 mm; or 16 mm to 26 mm, or any size subranges within the preceding ranges. The dispensing portion of the hand-dispensable cooked and packaged chunky food may be positioned/located, for example, at a top, bottom, corner, edge, or center position of the pouch, to facilitate dispensing of the food composition from the pouch. The dispensing portion may be, for example, resealable or recloseable with a resealable or recloseable closure or cap sized to meet applicable anti-choking hazard standards. The dispensing portion may, for example, comprise a fitment (which may be plastic) that includes an opening or aperture as described, with a replaceable closure. The closure may include one or more gripping features or gripping points to provide a mechanical advantage to facilitate opening of the closure by force (e.g., hand force) applied by a user (e.g., including children and elderly). The closure may be replaceable over the opening and may engage the dispensing portion and opening via a resealable fastening engagement that is a snap-fit engagement, a screw-on engagement, or the like. The pouch and the dispensing portion may, for example, be configured to provide a stand-up pouch, wherein the dispensing portion comprises a dispensing opening located at a top center position of the pouch to facilitate hand-mediated dispensing of the food composition from the pouch by a user. The pouch may, for example, comprise a gusset, and be of a single-serving size (e.g., 8 ounces, or any convenient single serving size, e.g., between 1 and 24 ounces, or between 2 and 20 ounces, or between 3 or 4 and 10, 12, or 16 ounces), or may be a larger pouch that can, for example, combine some multiple of a single serving size. The pouch is preferably self-venting, and may for example, be laser perforated to provide for self-venting during microwaving without a need for opening of the pouch or mixing of the food composition within the pouch. The package, e.g., pouch and dispensing portion may, optionally and preferable, be bisphenol A (BPA)-free.

Additional aspects provide methods for making a hand-dispensable cooked and packaged chunky food. Certain presently-preferred methods can be used to produce a hand-dispensable non-retort cooked and packaged chunky food having improved organoleptic and nutritional qualities. Example such methods comprise: cooking a chunky food under non-retort conditions at a cooking temperature(s) and for a time sufficient to provide a non-retort cooked chunky food composition having sized chunky food pieces that account for a mass percentage in the range of 5% to 95% of the food composition, in a heated state; and transferring, at a transferring temperature and at a transfer rate, the heated non-retort cooked sized chunky textured food composition into a hand-holdable, non-retort, microwaveable, self-venting flexible-film pouch having a dispensing portion sized and configured to provide for substantially unimpeded flow of the cooked sized chunky textured food composition during filling and hand-mediated dispensing thereof from the pouch, to provide a hand-dispensable non-retort cooked and packaged chunky food, wherein the transferring temperature and the transfer rate are sufficient to provide for filling (e.g., bottom-up) of the pouch without or substantially without trapped air pockets, and retention, or substantial retention of the sized chunky texture of the cooked food composition. In the methods, the chunky food, prior to cooking, may be sized (cut, chopped, sorted, etc.) to provide for substantially unimpeded passage through an opening or diameter in a range of at least 10, 12 or 14 mm to 35 mm; 16 mm to 30 mm; 16 mm to 26 mm; or any size subranges within the preceding ranges.

In the methods, the chunky food pieces may, for example, have a size dimension: in a range of at least 3, 4, 5, or 6 mm to 19 mm (⅛ to ¾ inch) and account for a mass percentage in the range of 10% to 90% (e.g., at least 15%, at least 20%, at least 30%, at least 40%, or at least 50%) of the food composition; in a range of 6 mm to 16 mm (¼ to ⅝ inch) and account for a mass percentage in the range of 10% to 90% (e.g., at least 15%, at least 20%, at least 30%, at least 40%, or at least 50%) of the food composition; in a range of 10 mm to 13 mm (⅜ to ½ inch) and account for a mass percentage in the range of 10% to 90% (e.g., at least 15%, at least 20%, at least 30%, at least 40%, or at least 50%) of the food composition; or any size and/or mass percentage subranges within the preceding ranges.

In example methods, a non-retort cooked chunky food composition may, for example, be cooked under non-retort conditions at a temperature in a range of: 74° C.-90.6° C. (165° F.-195° F.); 74° C.-93.3° C. (165° F.-200° F.); or less than 93.3° C. (less than 200° F.) to substantially reduce heat-induced degradation of at least one of flavor, color, texture, aroma or vitamins/nutrients. However, the cooked chunky food composition does not require a retort-cooking step or a sterilization or pasteurization step, and may be cooked by a non-retort method and packaged and refrigerated without undergoing a sterilization or pasteurization step, and may still have a commercially useful shelf life during refrigerated or frozen temperature storage.

Transferring may, for example, take place at a transferring temperature in a range of 79° C.-91° C. (approx. 175° F.-195° F.), and may, for example, be performed at a transfer rate selected from the group consisting of: less than or equal to 28.4 gm/sec (1 oz/sec), less than or equal to 56.7 gm/sec (2 oz/sec), less than or equal to 85 gm/sec (3 oz/sec), less than or equal to 113.4 gm/sec (4 oz/sec), less than or equal to 141.8 gm/sec (5 oz/sec), less than or equal to 170.1 gm/sec (6 oz/sec), and less than or equal to 283.5 gm/sec (10 oz/sec), or at a greater rate.

The methods may further comprise, after transferring, rapidly chilling the dispensable non-retort packaged chunky food to a chilled temperature suitable for food-safe storage, to provide a chilled, food-grade, dispensable (e.g., non-retort cooked) packaged chunky food, with a shelf-life selected from the time period group consisting of: at least 7 days, at least 14 days, at least 30 days, at least 60 days, at least 90 days, at least 120 days, at least 150 days, at least 180 days, at least 230 days, at least 360 days, any subranges between any of the preceding periods, and greater periods, in each case at a storage temperature value in a range of about 1° C. to about 4.4° C. (about 34° F. to about 40° F.). Preferably, the shelf-life of the chilled, food-grade, dispensable non-retort packaged chunky food is a shelf-life selected from the time period group consisting of: at least 60 days, at least 90 days, at least 120 days, at least 150 days, at least 180 days, and any subranges between any of the preceding periods, in each case at a storage temperature value in a range of about 1° C. to about 4.4° C. (about 34° F. to about 40° F.).

Rapidly chilling may, for example, comprise reducing the temperature to a value in the range of about 1° C. to about 4.4° C. (about 34° F. to about 40° F.) within a time period selected from the group consisting of: 0.5 hr. or less, 1 hr. or less, 2 hr. or less, 3 hr. or less, 4 hr. or less, 5 hr. or less, or 6 hr. or less, to provide for increased food quality and safety. The methods may further comprise, after chilling, storing the chilled, dispensable non-retort packaged chunky food at a storage temperature (e.g., in a range of about 1° C. to about 4.4° C. (about 34° F. to about 40° F.)) suitable for food-safe storage. For example, the chilled temperature and the storage temperature may be the same, or substantially the same.

In the methods, the dispensing portion of the hand-dispensable cooked and packaged chunky food may be positioned/located, for example, at a top, bottom, corner, edge or center position of the pouch to facilitate dispensing of the food composition from the pouch, especially with the ability of a user to direct flow of the food composition from the pouch directly to the user's mouth. The dispensing portion may be, for example, resealable (or “re-closeable”) with a resealable closure or cap sized to meet applicable anti-choking hazard standards. The dispensing portion may, for example, comprise a fitment with an over-sized closure having one or more gripping features or gripping points to provide a mechanical advantage to facilitate opening of the closure by force (e.g., hand force) applied by a user (e.g., including children and elderly). The pouch and the dispending portion may be configured (e.g., internally shaped) to provide for directed flow of the cooked packaged chunky food during hand-mediated dispensing thereof. The pouch and the dispensing portion may, for example, be configured to provide a stand-up pouch, wherein the dispensing portion comprises a dispensing opening located at a top center position of the pouch to facilitate hand-mediated dispensing of the food composition from the pouch by a user.

The pouch may, for example, comprise a gusset, and be of a single-serving size (e.g., 8 ounces), or any convenient size (e.g., between 1 and 20 ounces, such as from 4 to 10 ounces).

The pouch, if microwaveable, may preferably be self-venting, and may, for example, be laser perforated to provide for self-venting during microwaving without a need for opening of the pouch or mixing of the food composition within the pouch. The pouch and fitment may, for example, be bisphenol A (BPA)-free.

In the methods, after cooking and packaging, the cooked chunky food composition may, for example, be refrigerated at a temperature value in a range of about 1° C. to about 4.4° C. (about 34° F. to about 40° F.). The hand-dispensable cooked and packaged chunky food may, for example, comprise no added preservatives, or may comprise only naturally-occurring preservatives. Alternately, the methods may comprise adding an artificial preservative agent to the chunky.

In the methods, the hand-dispensable cooked and packaged chunky food may, for example, provide a full caloric density of a main meal.

Yet further aspects provide a hand-holdable, non-retort food-dispensing pouch for chunky foods, comprising a hand-holdable, non-retort, microwaveable, self-venting flexible-film pouch having a dispensing portion sized and configured to provide for substantially unimpeded flow of a cooked chunky food composition having sized chunky food pieces that account for a mass percentage in the range of 5% to 100% of the food composition during hand-mediated dispensing thereof from the pouch. The dispensing portion is sized and configured to provide for substantially unimpeded flow of a chunky food composition having chunky food pieces, and can include an opening or aperture having a size dimension in a range of: from at least 10, 12, or 14 mm to 35 mm; 16 mm to 30 mm; 16 mm to 26 mm; or any size subranges within the preceding ranges. The dispensing portion is sized and configured to provide for substantially unimpeded flow of a chunky food composition having chunky food pieces with a size dimension in a range of: at least 3, 4, 5, or 6 mm to 19 mm (⅛ to ¾ inch) and account for a mass percentage in the range of 10% to 90% (e.g., at least 15%, at least 20%, at least 30%, at least 40%, or at least 50%) of the food composition; in a range of 6 mm to 16 mm (¼ to ⅝ inch) and account for a mass percentage in the range of 10% to 90% (e.g., at least 15%, at least 20%, at least 30%, at least 40%, or at least 50%) of the food composition; in a range of 10 mm to 13 mm (⅜ to ½ inch) and account for a mass percentage in the range of 10% to 90% (e.g., at least 15%, at least 20%, at least 30%, at least 40%, or at least 50%) of the food composition; or any size and/or mass percentage subranges within the preceding ranges.

The dispensing portion may be positioned/located, for example, at a top, bottom, corner, edge, or center position of the pouch to facilitate dispensing of the food composition from the pouch. The dispensing portion may be, for example, resealable with a resealable closure or cap sized to meet applicable anti-choking hazard standards. The dispensing portion may, for example, comprise a fitment with an over-sized closure having one or more gripping features or gripping points to provide a mechanical advantage to facilitate opening of the closure by force (e.g., hand force) applied by a user (e.g., including children and elderly). The pouch and the dispending portion may be configured (e.g., internally shaped) to provide for directed flow of the non-retort cooked packaged chunky food during hand-mediated dispensing thereof. The pouch and the dispensing portion may, for example, be configured to provide a stand-up pouch, wherein the dispensing portion comprises a dispensing opening located at a top center position of the pouch to facilitate hand-mediated dispensing of the food composition from the pouch by a user. The pouch may, for example, comprise a gusset, and be of a single-serving size (e.g., 8 ounces), or any convenient size (e.g., between 1 and 20 ounces). The pouch is preferably self-venting, and may, for example, be laser perforated to provide for self-venting during microwaving without a need for opening of the pouch or mixing of the food composition within the pouch. Any self-venting means (e.g., rupturable seal formed in the pouch that is reliably broken before other pouch seals) that precludes a user from having to open the pouch are encompassed within the methods. The package, e.g., pouch and fitment, may, for example, be bisphenol A (BPA)-free. The hand-holdable, non-retort food-dispensing pouch may, for example, comprise one or more flexible film layers. The hand-holdable, non-retort food-dispensing pouch preferably comprises no foil or metallic-based layers that would preclude microwaving. The dispensing portion is preferably made from non-electrically conductive materials and/or non-heat conductive materials. The hand-holdable, non-retort food-dispensing pouch may, for example, comprise one or more cool-touch area(s) at or near the top of the pouch and/or near the dispensing portion to enable, in use of the pouch, grasping after microwaving.

In one aspect, the invention relates to a packaged food product that includes: cooked, chunky food composition in a flexible package. The package includes a dispensing portion adapted to allow hand-dispensing of the food product to a user's mouth.

In another aspect the invention relates to a method of preparing a packaged food product that includes a cooked, chunky food composition in a flexible package, the package including a dispensing portion adapted to allow hand-dispensing of the food composition to a user's mouth. The method includes: cooking the chunky food composition, and placing the cooked food composition in the flexible package.

### BRIEF DESCRIPTION OF THE DRAWINGS

FIG. 1 shows a prior art pouch used for conventional (e.g., retort processed) foods.

FIGS. 2A and 2B show, according to particular aspects of the present invention, embodiments of Applicant's pouch for cooked, packaged chunky food compositions, e.g., for a non-retort cooked packaged chunky food compositions.

FIG. 3 shows, according to particular aspects of the present invention, an additional embodiment of Applicant's pouch for non-retort cooked packaged chunky food compositions.

FIG. 4 shows a method of hand-dispensing a food composition from a packaged food product as described, including directing a food composition directly into the mouth of the user.

FIG. 5 shows, according to particular aspects of the present invention, a non-retort cooked macaroni and cheese chunky food composition embodiment after hand-mediated dispensing from a non-retort, self-venting, microwavable pouch.

### DETAILED DESCRIPTION

The invention of the following description relates to packaged food products that include a chunky cooked food composition contained in a hand-holdable package from which the chunky cooked food composition can be easily dispensed, particularly, by hand-dispensing the chunky food composition from a dispensing portion of the package directly to a mouth of consumer. The food composition is cooked, and may optionally and preferably be cooked using a non-retort cooking step to prevent degradation of the chunky food composition that may be caused by high temperature conditions of a retort cooking step. The packaged food product may be stored at refrigerated or frozen conditions, and heated (by use of a microwave oven, or otherwise, depending on the packaging) before being consumed.

Particular aspects of the present invention provide food-safe methods for producing, packaging, and dispensing non-retort cooked chunky food having high organoleptic (e.g., flavor, texture, aroma, color, etc.), nutritive (vitamins, nutrients, etc.) quality, and with an extended refrigerated shelf-life relative to prior art refrigerated prepared foods.

Additional aspects relate to the packaged chunky foods produced by the methods, and to packaging containers (e.g., self-venting containers, cups with lids, pouches, etc.) that include a dispensing portion that allows for easily dispensing the packaged chunky food (e.g., by hand from a pouch, including by a child or elderly adult, optionally by dispensing the food composition directly to the mouth of a user).

The methods provide flavorful, kid-friendly (or for adults) hand-dispensable cooked (e.g., non-retort cooked) and packaged chunky foods, e.g., as a snack, meal, or a partial meal, and which contain particulates such as chunky meat (e.g., pork, chicken, beef, etc.), fish, vegetable pieces, cheese, macaroni, pasta, spaghetti, other types of noodles, rice, beans, etc.). Some example methods may surprisingly provide for high organoleptic quality with an extended refrigerated shelf-life relative to prior art refrigerated prepared foods, with no requirement for added preservatives.

Without being bound by mechanism, retention of organoleptic quality and provision of extended refrigerated shelf-life, which can be properties of preferred cooked chunky food compositions of the present description, are surprising and unexpected result reflecting a combination of at least five process factors, including: (i) non-retort cooking of appropriately-sized and configured foods; (ii) hot-filling after cooking (iii) low-shear hot-filling at an appropriate transfer temperature and transfer rate into a container (e.g., microwavable pouch); through (iv) a dispensing portion configured to provide for substantially unimpeded flow of the cooked sized chunky textured food composition during filling and hand-mediated dispensing thereof from the pouch; and (v) immediately after hot-filling, rapidly chilling and storage under refrigerated or frozen conditions.

According to particular aspects, and with respect to (i) above, flavorful, kid-friendly hand-dispensable (optionally non-retort) cooked and packaged chunky food meals (e.g., chunky meat, cheese, pasta, rice, beans, etc.) with high amounts of large particulates are provided with a size dimension in a range of: from at least 3, 4, 5, or 6 mm to 19 mm (⅛ to ¾ inch) and account for a mass percentage in the range of 10% to 90% (e.g., at least 15%, at least 20%, at least 30%, at least 40%, or at least 50%) of the food composition; in a range of 6 mm to 16 mm (¼ to ⅝ inch) and account for a mass percentage in the range of 10% to 90% (e.g., at least 15%, at least 20%, at least 30%, at least 40%, or at least 50%) of the food composition; in a range of 10 mm to 13 mm (⅜ to ½ inch) and account for a mass percentage in the range of 10% to 90% (e.g., at least 15%, at least 20%, at least 30%, at least 40%, or at least 50%) of the food composition; or any size and/or mass percentage subranges within the preceding ranges. The meals are packaged in convenient (e.g., self-venting microwavable, low-mess hand-held and hand-dispensable) pouches, e.g., in individual meal size (e.g., 8 oz). The hand-dispensable cooked and packaged chunky food meals are assembled and cooked, preferably using non-retort conditions of less than 93.3° C. (less than 200° F.), (e.g., at a temperature in a range of 74° C.-90.6° C. (165° F.-195° F.) to substantially reduce or avoid heat-induced degradation of at least one of flavor, color, texture, aroma or nutrients, which qualities are significantly degraded by the standard retort methods used in the art that involve the use of high heat (e.g., 240-250° F. (116-121° C.), long cooking times, and pressure.

According to particular aspects, and with respect to (ii) and (iii) above, the cooked chunky meals may then be transferred, under hot-fill conditions (79° C.-91° C. (approx. 175° F.-195° F.)), into packages (e.g., microwavable pouches) having filling/dispensing portions (spouts, fitments) configured to provide for substantially unimpeded flow of the cooked sized chunky textured food composition during filling and hand-mediated dispensing thereof from the pouch. The transferring temperature (79° C.-91° C. (approx. 175° F.-195° F.)) and the transfer rate (e.g., a transfer rate selected from the group consisting of: less than or equal to 28.4 gm/sec (1 oz/sec), less than or equal to 56.7 gm/sec (2 oz/sec), less than or equal to 85 gm/sec (3 oz/sec), less than or equal to 113.4 gm/sec (4 oz/sec), less than or equal to 141.8 gm/sec (5 oz/sec), less than or equal to 170.1 gm/sec (6 oz/sec), and less than or equal to 283.5 gm/sec (10 oz/sec), or at a greater rate), are configured to provide for filling (e.g., bottom-up filling) of the pouch without, or substantially without trapped air pockets, and substantial retention of the sized chunky texture of the cooked food composition.

For example, batch transfer or low-shear pumping of the hot cooked chunky food into a filling hopper mitigates against textural degradation of the ingredients during bulk flow. The cooked chunky food composition, while still hot from the cooking, is loaded, at a first station, into a filler hopper and a filler nozzle is mated to, e.g., a fitment of a non-retort microwavable pouch. The correct weight of the cooked chunky food composition is deposited into the pouch with the avoidance of air pockets, and the filled pouch is conveyed to a second station where a closure is removably attached to (e.g., screwed onto) the fitment. The sealed, filled pouch is then conveyed out of the filler. For example, chunky meal output from the cooking stage (e.g., cooking kettles) is conveyed to a filler hopper, for example, by low-shear pumping through piping interconnect or by batch-wise tub transfer to eliminate or reduce shear-damage to the cooked chunky food. The cooked chunky food is loaded into a pre-heated (e.g., insulated, heated) hopper that serves as both a feeder and surge balance. A piston, in fluid communication with the hopper/feeder, is calibrated and adjusted to deposit a desired fill weight into pouches. For example, prefabricated pouches having fitments are conveyed to the filler and lined up on a rail system hanging by the necks of the fitments. A robotic gripper lifts a pouch from the rail and positions it into the filling station. Alternatively, instead of robotic gripping and positioning, a rotating carousel is configured to pull the next pouch in sequence by the neck into the fill position. Optionally, the pouch is primed for filling. For example, a nozzle is mated to the fitment and forms a seal. A set amount of filtered air is shot into the pouch to expand it. Alternatively, a robotic gripper with suction cups attaches to the front and back face of the pouch and pulls it open. A nozzle is mated to the fitment and forms a seal, and the piston pump fills the pouch by depositing the correct/desired amount of weight into the pouch. The pouch is then conveyed to a capper where a closure is screwed onto the fitment to seal the filled pouch, and the pouch is conveyed out of the filler/capper station.

In alternative fill embodiments, the pouches, with or without fitments, are made using rollstock film right before they are filled. The filling steps are the same as described above, except that the pouch may optionally be filled with the cooked chunky food composition before the fitment is sealed into place on the pouch. Additionally, when making pouches from rollstock right before filling, a fitment already having a closure may be added to the filled pouch to seal it, or a fitment without a closure could be added before or after filling, and the closure could then be added.

In contrast to conventional liquids, pastes, and purees having easy-flowing consistency, the disclosed chunky food compositions have high ratios of large particles that collide and jostle each other as they flow, potentially degrading the textural quality of the chunky food.

According to particular aspects, Applicant discovered a solution to the problem of preserving the texture of Applicant's cooked chunky food compositions during filling, comprises: sizing of ingredients to provide for 1 mm to 2 mm clearance through the dispensing portion opening (except flexible resilient ingredients, such as pasta, equal to or larger than the fitment may yet pass through the fitment with low or no shear damage through the fitment); conducting the pouch filling immediately after cooking to kill microbes on the inner pouch surfaces (and avoid temperature cycling from hot to cold and back to hot); and low-shear filling at a temperature (as discussed above); and at a fill rate (as discussed above; e.g., at a fill rate less than or equal to 56.7 gm/sec (2 oz/sec) or less than or equal to 85 gm/sec (3 oz/sec), etc.) sufficient to provide for substantial retention of the chunky food texture by providing for low-shear, substantially unimpeded flow of the cooked sized chunky textured food composition during filling (and also during subsequent hand-mediated dispensing thereof from the pouch). Filling, immediately after cooking, while the chunky food is still hot from cooking, and at an appropriate fill temperature and rate, reduces viscosity thereby improving flow and reducing shear damage, and additionally enhances sanitation of the packaging and headspace. Appropriate fill rate of the cooked chunky food composition into the pouch ensures, for example, that the pouch is filled, preferably, from the bottom-up to minimize splashback and eliminate air pockets within the packaged product.

According to particular aspects, and with respect to (iv) above, the dispensing portion of the hand-dispensable non-retort cooked and packaged chunky food may comprise, for example, a tear-open spout or a fitment, to provide an opening or diameter in a size range of: from at least 10, 12, or 14 mm to 35 mm; 16 mm to 30 mm; or 16 mm to 26 mm; or any size subranges within the preceding ranges.

Example dispensing portions can be in the form of an opening that is present on the package or that can be formed on the package, e.g., at a corner, by removing, tearing, or cutting a portion of the package. The dispensing portion may or may not include a plastic piece (e.g., “fitment”) that includes a channel, spout, funnel, tube or other type of a flow duct, conduit, or passage through which the cooked chunky food composition can be dispensed from the interior of the package, to an exterior of the package, e.g., directly into a mouth of a user. Dispensing the chunky food composition in this manner can be performed by placing pressure on the flexible package, e.g., by hand or by suction (negative internal pressure), to cause the chunky food contents of the package to flow out of the dispensing portion.

According to particular aspects, and with respect to (v) above, immediately (e.g., promptly, as soon as possible) after filling, the packaged chunky food is rapidly chilled and stored under refrigerated conditions. For example, wherein rapidly chilling comprises reducing the temperature to a value in the range of about 1° C. to about 4.4° C. (about 34° F. to about 40° F.) within a time period selected from the group consisting of: 0.5 hr. or less, 1 hr. or less, 2 hr. or less, 3 hr. or less, 4 hr. or less, 5 hr. or less, or 6 hr. or less, followed by cold storage at a temperature value in the range of about 1° C. to about 4.4° C. (about 34° F. to about 40° F.), to provide for increased food quality and safety. As known in the art, extended durations at high temperatures degrades both organoleptic (e.g., color, flavor, texture, aroma, moisture content, etc.) and nutritive food qualities (vitamins and nutrients, etc.). According to particular aspects, rapid chilling reduces the duration at high temperature and preserves these qualities to a high degree. Applicant's pouches may be hot-filled, and still at approximately 80° C. (175° F.) after coming out of the filler/capper stations.

To achieve the rapid cooling targets any suitable cooling method may be used. For example, two cooling methods that may be applied at this point, depending on capacity are: (a) immediate submersion in a stationary ice water bath, followed by a placement in a chilled water bath that is routinely agitated; or (b) transfer into a water cooling tower where pouches tumble in a flowing stream of chilled water. The disclosed cooked chunky food compositions may be stored, marketed, and sold refrigerated. Once the packaged chunky food compositions hit the target chilled temperature, they are removed from the chilling system and moved into cold storage where the preferred acceptable temperature range is 2° C. (36° F.) to 5° C. (41° F.), with a usual target of 4° C. (39° F.). According to further aspects, freezing provides a rapid cooling option, and storage, marketing, and sale may be in the frozen state.

According to particular preferred aspects, the pouch may be a microwavable pouch with a resealable fitment with an oversized closuring providing a convenient, on-the-go no-mess eating and clean-up experience. The resealable oversized closure facilitates ease of use/opening/closing, and minimizes choking hazards. The relatively large fitment openings (in a size range of: from at least 10, 12, or 14 mm to 35 mm; 16 mm to 30 mm; or 16 mm to 26 mm; or any size subranges within the preceding ranges), while yet suitable for delivering chunk foods to small mouths (e.g., children), provide for substantially unimpeded dispensing of large particulate chunky food composition, with retention of texture, as disclosed herein. A preferred top-center fitment location facilitates orienting the pouch relative to a user's face and mouth, and further facilitates full evacuation of the pouch contents. Preferably, pouch laser perforating is used to provide self-venting ability when microwaving, without a need for opening the pouch nor mixing the contents thereof. Preferably, the pouch is sized for a single serving usage, and/or provides a full caloric density of a main meal. Preferably, a pouch stand-up configuration/design feature facilitates ease of merchandising, and microwaving.

According to additional preferred aspects, a cooked chunky food composition container (e.g., pouch) as described herein can be made from any suitable flexible film(s) (e.g., HDPE, LLDPE, Nylon, etc.), and may be comprised of multiple layers, but optimally does not comprise non-microwavable material (e.g., foil- or metallic-based layers). Pouches may comprise printed graphics or adhesive labels. Examples of useful or presently-preferred pouch materials can have an overall thickness between about 4-6 mil, preferably between about 4.5-5.5 mil. Examples of useful or presently preferred pouch dimensions may be about 152×100 mm (l×w) (not including fitment height), preferably, 140×100 mm with gusset depth of 50 mm to 70 mm, preferably with a gusset depth of 55 mm with approximate L/D ratio of about 1.6:1 when filled with seal widths between about 3-7 mm. Preferably, fitments are made from non-electrically conductive, non-heat conductive material (e.g., inert polymers), with fitment preferred inside diameters (ID) between about 16-25 mm, such as about 21 mm with closure.

According to further preferred aspects, the pouches may comprise a stand-up feature to enable ease of merchandising and ease of storage. The pouches may additionally comprise at least one cool touch area(s) at, for example, the top of pouch near the fitment, to enable safely grasping a heated pouch after microwaving. Preferably, the pouches have laser perforating near top of pouch, for example above a fill-line, to enable self-venting when microwaving. Preferably, a pouch may additionally comprise a transparent section (e.g., window) to enable viewing of contents by a purchaser/user/consumer. Preferably, the pouches are internally shaped by adjusting seal area and shapes (e.g., tapered, conical, etc.) to facilitate directed flow of contents with hand-mediated dispensing.

According to yet further aspects, the disclosed methods may optionally use a cooking temperature lower than retort or UHT, which is less detrimental to organoleptic quality than retort. The disclosed cooking methods, (e.g., keeping temperature below 200° F.; 93.3° C.) are similar to traditional cooking methods and result in consumer-preferred flavor profiles. As described above, the disclosed lower maximum cooking temperature, hot-fill, rapid chill process helps to maintain organoleptic quality and sanitize the package (e.g., pouch). In preferred aspects, small package size (e.g., from about 1 to 20, e.g., from about 4 to 8 oz.; about 113.4 to 226.8 gm) allows for even more rapid chilling, thereby improving safety and product quality. The methods preserve organoleptic qualities and provide for retention of heat liable vitamins.

According to further aspects, the non-retort cooked packaged chunky food compositions are optionally subjected to high pressure processing (HPP) (a pasteurization technique by which products, already sealed in a final package, are introduced into a vessel and subjected to a high level of isostatic pressure (300-600 MPa; 43,500-87,000 psi) typically transmitted via water). Pressures above 400 MPa/58,000 psi at cold (e.g., 4° C. to 10° C.) or ambient temperature inactivate the vegetative flora (bacteria, virus, yeasts, molds and parasites) present in food, extending the products shelf life. Relative to retort processes, HPP better retains organoleptic and nutritional properties of food.

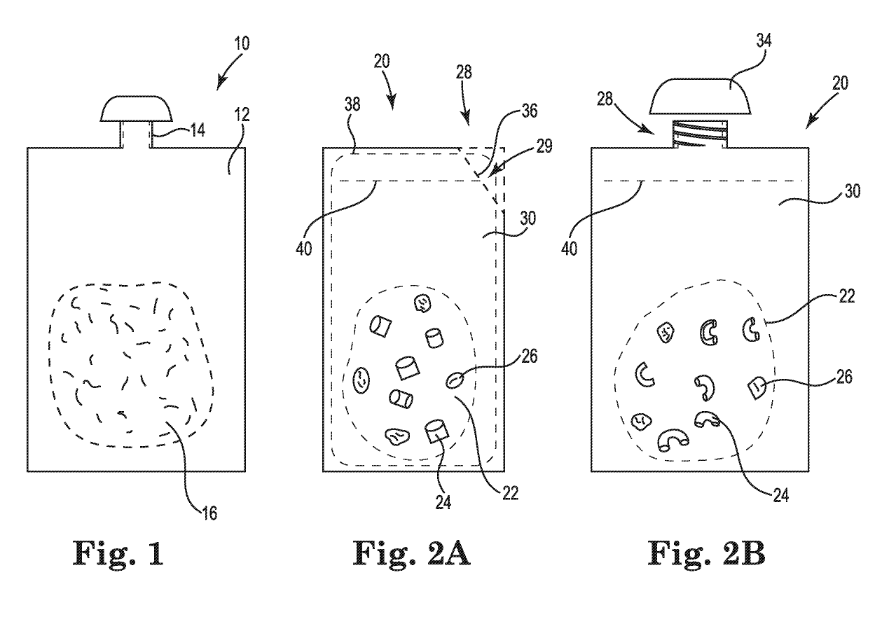

Referring now to FIG. 1, this shows an example of a prior art non-chunky food composition such as applesauce or another fruit or vegetable puree, in a pouch. Packaged food product 10 includes pouch 12 with spout 14. The package contains puree (e.g., applesauce or baby food) 16, which is not a chunky food as described herein, and which is cooked using a retort-cooking process. Spout 14 is sized to allow for puree 16 to pass through spout 14, e.g., is 8 millimeters at an inner diameter. The package contains a metallized layer and is not microwaveable, i.e., is not capable of being heated in a microwave oven.

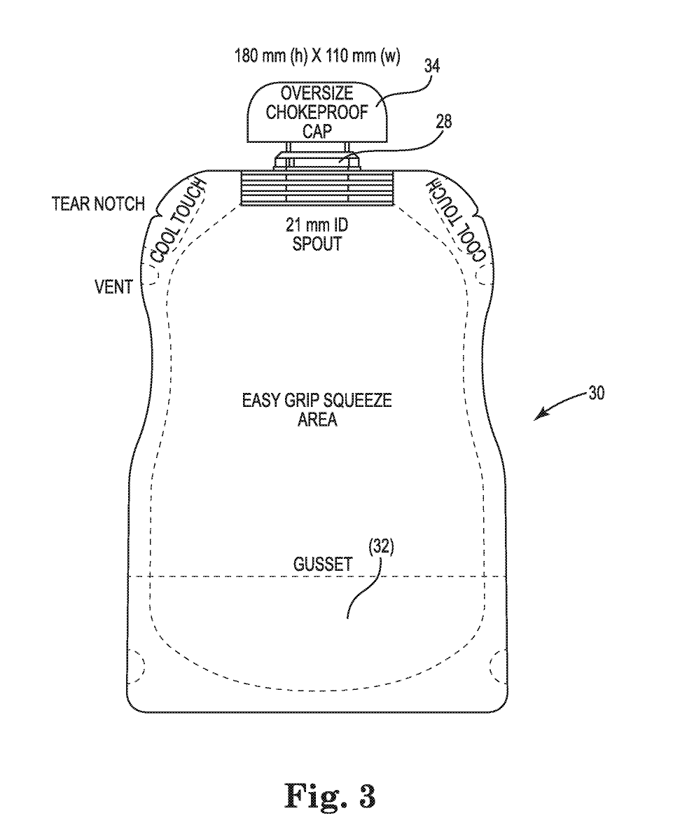

Referring now to FIGS. 2A and 2B, these show examples of packaged food products 20 of the present description, including chunky food composition 22, such as pasta pieces 24 and optional meat particles 26, or ingredients of another chunky food composition. Example packaged food products 20 each include pouch 30 with dispensing portion 28. Dispensing portion 28 of each package is sized to allow for particles of chunky food composition 22, including pasta pieces 24 and meat particles 26, to pass through an opening of each example dispensing portion 28. The pouch is preferably capable of being heated in a microwave oven, i.e., is microwaveable, and contains no metal layer or metal foil, e.g., contains only plastic materials for the flexible package, and is optionally and preferably self-venting. Chunky food composition may be cooked by a retort-cooking process or by a non-retort-cooking process.

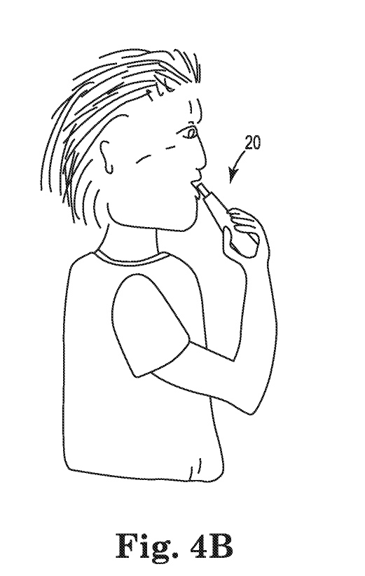

At FIG. 2A, pouch 30 includes a dispensing portion 28 in the form of a tear open spout at a corner. A portion of the corner of pouch 30 can be formed into a corner opening 29 of pouch 30 by cutting or tearing away the corner of pouch 30, e.g., at dashed line 36. Tearing away or removing the corner of pouch 30 by cutting or tearing at dashed line 36 creates opening 29 in the pouch, at the corner, that connects an interior space of pouch 30 designated by dashed line 38, with an exterior of pouch 30. After producing opening 29 by cutting or tearing away the corner at dashed line 36, chunky food composition 22 can be dispensed from opening 29 by applying pressure, e.g., manually, to opposite sides of pouch 30, to cause chunky food composition 22 to be squeezed through corner opening 29 of dispensing portion 28. Optionally, and according to certain methods of the present description, chunky food composition 22 can be dispensed directly from pouch 30, through opening 29 of dispensing portion 28, into a mouth of a user. See FIGS. 4A and 4B. To facilitate forming the opening of dispensing portion, pouch 30 can include text, a graphic dashed line, perforations, or a notch or cut at a location of dashed line 36.

At FIG. 2B, chunky food composition 22 can be dispensed from an opening or aperture of dispensing portion 28 by removing cap 34 and applying pressure, e.g., manually, to opposite sides of pouch 30, to cause chunky food composition 22 to be squeezed through the opening of dispensing portion 28. Optionally, and according to certain methods of the present description, chunky food composition 22 can be dispensed directly from pouch 30 into the mouth of a user. See FIGS. 4A and 4B. Cap 34 is removable and replaceable.

Optionally, pouch 30 (of FIG. 2A and of FIG. 2B) can be gusseted on its vertical sides and on its bottom end, and can be configured to stand vertically on the gusseted bottom end (e.g., a lower or shorter end). Pouch 30 can be microwaveable, and can include optional scoring 40, which is a self-venting mechanism (e.g., laser perforations) that opens during microwave heating to vent the interior of pouch 30.

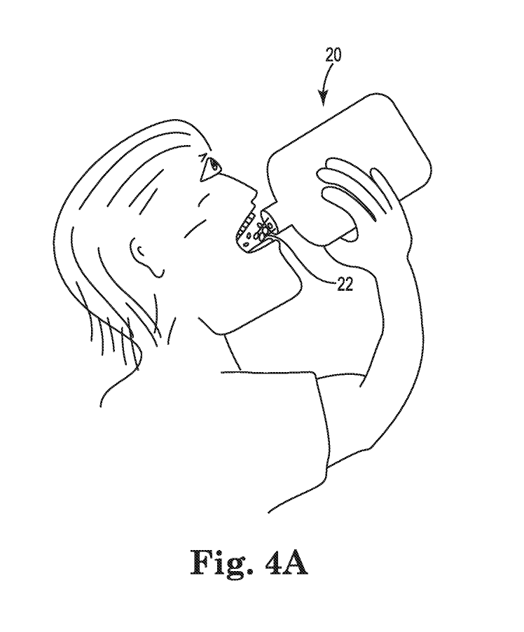

FIG. 3 shows an example self-venting pouch 30 as described, that includes dispensing portion 28 having an exemplary diameter of about 21 millimeters (inner diameter). Cap 34 is removable and replaceable. Gusset 32 is present at a lower portion and bottom. Example dimensions include outer edges that may be about 100 millimeters in width across the bottom, and 140 millimeters in height, to form a rectangular pouch having a rectangular or approximately rectangular interior, useful to contain a chunky food composition. Cap 34 can be removable and replaceable.

FIGS. 4A and 4B show a user 40 dispensing chunky food composition 22 from an example packaged food product 20 of the present description, e.g., as shown at FIG. 2A or 2B. As shown in FIG. 4A, a user may hold a packaged food product 20 in an inverted position and, using hand pressure on exterior surfaces of the package, squeeze food product 20 out of the dispensing portion. Alternatively, as shown at FIG. 4B, the package may be held in a vertical or nearly-vertical orientation with the dispensing portion positioned at the top of product 20 to dispense food composition 22 from the package by squeezing the flexible package.

As an option for a package as described, the package can include thermochromic ink at an exterior surface. The thermochromic ink can be adapted to indicate a temperature range, or a change in temperature, of the contents of the package. For example: a red color of the thermochromic ink may be used to indicate a hot food product, a yellow color of the ink may be used to indicate a warm food product, and a blue color of the ink may be used to indicate a cool food product.

### Terms (Definitions)

Unless otherwise explained, all technical and scientific terms used herein have the same meaning as commonly understood by one of ordinary skill in the art to which this disclosure belongs.

The singular terms “a,” “an,” and “the” include plural referents unless context clearly indicates otherwise. Similarly, the word “or” is intended to include “and” unless the context clearly indicates otherwise.

Although methods and materials similar or equivalent to those described herein can be used in the practice or testing of this disclosure, suitable methods and materials are described below. The term “comprises” means “includes.” The abbreviation, “e.g.” is derived from the Latin exempli gratis, and is used herein to indicate a non-limiting example. Thus, the abbreviation “e.g.” is synonymous with the term “for example.”

In order to facilitate review of the various embodiments of this disclosure, the following explanations of specific terms are provided: The terms “retort” or “retort cooked,” as used herein, refers generally to art-recognized thermal processing methods for sterilizing foods packaged in hermetically sealed containers, including the methods as described under 21 C.F.R. § 113. Typically, retort cooking involves cooking at high temperature (e.g., 240-250° F. (116-121° C.)) under pressure for a specified time. For example, in steam retort processes, the retort vessel is saturated with steam while air is eliminated through an open come-up vent valve and the vessel reaches a vent temperature. The come-up vent is then closed, and temperature is brought to cook temperature, followed by a cook step with maintained cook temperature. After the cook step, cooling water is introduced (pressure cool fill), with overriding pressure control, into the retort vessel to collapse the steam, which is displaced by air; increased pressure from rising water levels is balanced by pressure release through a BPR valve and an air valve is used to make up pressure. A pressure cool step follows the pressure cool fill step, wherein cooling water continues to flow through the retort vessel at a controlled level while recipe pressure is maintained for a time until recipe temperature is met. The retort cooling process then continues with an atmospheric cool step, wherein cooling water continues to circulate, but pressure is relieved by opening a vent valve and a temperature set point is achieved. The water is then drained from the retort vessel.

The term “retort package,” as used herein, refers generally to a package configured to be hermetically sealed and capable of maintaining a hermetically-sealed state during retort cooking of a food composition hermetically-sealed within the retort package.

The terms “non-retort,” “non-retort cooked,” and “non-retort packaged,” as referred to herein, generally means a cooking method that is not retort cooking as defined above. In particular aspects disclosed herein, cooking under non-retort conditions refers to cooking at a temperature in a range of 74° C.-90.6° C. (165° F.-195° F.) for a desired period, to substantially reduce heat-induced degradation of at least one of flavor, color, texture, aroma, or nutrients relative to retort methods.

The term “HPP,” as referred to herein, means high pressure pasteurization (HPP) which is a non-heated pasteurization technique by which products, already sealed in a final package, are introduced into a vessel and subjected to a high level of isostatic pressure (300-600 Mpa; 43,500-87,000 psi) transmitted by water).

The term “UHT,” as referred to herein, generally means ultra-high temperature (UHT) processing comprising fast convective heat transfer in heat exchangers, or use of steam injection to reduce process time with minimal come-up and cool-down time.

Typically, UHT processing comprises heating at a temperature above 135° C. (275° F.) for a relatively brief period (e.g., seconds or minutes).

The terms “chunky” or “chunky textured,” as referred to herein, means food ingredients comprising high amounts of large particulates having a size dimension: in a range of: from 3, 4, 5, or 6 mm to 19 mm (⅛ to ¾ inch) and accounting for a mass percentage in the range of 10% to 90% (e.g., at least 15%, at least 20%, at least 30%, at least 40%, or at least 50%) of the food composition; in a range of 6 mm to 16 mm (¼ to ⅝ inch) and accounting for a mass percentage in the range of 10% to 90% (e.g., at least 15%, at least 20%, at least 30%, at least 40%, or at least 50%) of the food composition; in a range of 10 mm to 13 mm (⅜ to ½ inch) and accounting for a mass percentage in the range of 10% to 90% (e.g., at least 15%, at least 20%, at least 30%, at least 40%, or at least 50%) of the food composition; or any size and/or mass percentage subranges within the preceding ranges.

The term “food composition,” as referred to herein, means food for consumption by a consumer. In particular aspects, the consumer is a human (e.g., a child or other aged human).

The term “food pieces” or “food chunks,” as referred to herein, means food particles.

The term “self-venting pouch,” as referred to herein, means a pouch comprising a venting mechanism (e.g., laser perforating, or pressure sensitive seams, or valve, etc.) configured to open, unassisted by a user, under pressure to allow venting of the pouch interior during heating (e.g., microwaving, etc.) of the pouch. Laser perforating creates accurate breathable features that enable vapor and gas exchange through controlled hole size and location. Laser perforated films exhibit holes that are uniform, strong, and clean of residue. As will be understood, other forms of self-venting mechanisms may be used, provided that they are configured to open, unassisted by a user, under pressure to allow venting of the pouch interior during heating (e.g., microwaving, etc.) of the pouch.

The term “flexible-film pouch,” as referred to herein, means a pouch constructed of a flexible material (e.g., film). In particular aspects herein, the pouch is made from any suitable flexible film(s) (e.g., HDPE, LLDPE, Nylon, etc.), and may be comprised of multiple layers, but optimally does not comprise non-microwavable material (e.g., foil- or metallic-based layers).

The phrase “substantially unimpeded flow,” as referred to herein, means a flow of chunky food composition that is not obstructed or hindered, so as to not to degrade the chunky texture of the cooked food composition. In particular aspects herein, the dispensing portions are sized so that flow of the chunky food particles during filling and/or dispensing from a container (e.g., pouch fitment) is not obstructed or hindered, so as to not to degrade the chunky texture of the cooked food composition. In particular aspects, a food particle (e.g., cooked macaroni and the like) may be larger than the aperture of the dispensing portion flexible, but yet sufficiently flexible/deformable to pass through the aperture without substantially decreasing the flow rate (e.g., at a given flow pressure), or degrading the chunky texture of the chunky food particles of the cooked chunky food composition.

The phrase “wherein the chunky food pieces have a size dimension,” as referred to herein, means that food particles/pieces of the chunky food have a size dimension (length, width, height, diameter, span, etc.) of a particular size.

The term “mass percentage,” as referred to herein, means percentage by weight.

The term “dispensing portion,” as referred to herein, generally refers to an aperture portion of a pouch through which food compositions are either filled and/or dispensed.

The term “tear-open feature,” as referred to herein, generally refers to a portion of a container (e.g., pouch) that is opened by a user by tearing, or the like, to create an opening for dispensing food.

The term “fitment,” as referred to herein, generally means a resealable dispensing portion, integrated into a container (e.g., sealed between seams of a pouch) that can be reversibly opened and closed by a user (e.g., screw caps, flip tops, etc.).

The phrase “to provide an opening or diameter,” as referred to herein, means to provide an opening having a dimension (length, width, height, diameter, span, etc.) of a particular size.

The term “stand-up pouch,” as referred to herein, means a pouch which can be placed in a stand-up position (e.g., long-dimension up) on a surface. In particular aspect, stand-up pouches have a gusset configured within the pouch structure to provide for a stand-up pouch.

The term “food quality” or “retaining food quality,” as referred to herein, means at least one organoleptic quality (e.g., flavor, color, texture, aroma, etc.) or nutritive quality (e.g., nutrients, vitamins, etc.).

The term “food-grade,” as referred to herein, means the art recognized food grade certification governed by the FDA.

A “preservative” is an agent that can be natural or artificial, and is added to a composition to prevent decomposition due to chemical change or microbial action. In the context of food compositions, a preservative may, e.g., be added to chemically preserve the food, and/or prevent microbial (e.g., bacterial and fungal) growth.

A “naturally occurring preservative” is a preservative that occurs naturally or is not produced by a non-natural (e.g., commercial or synthetic) chemical reaction. Examples include natural extracts such as essential oils, milk solids, the presence of an acid to lower pH.

The term “preservative-free” indicates that no preservative is added to the composition.

The term “chilling” or “rapidly chilling,” as referred to herein, means reducing the temperature to a value in the range of about 1° C. to about 4.4° C. (about 34° F. to about 40° F.) within a time period selected from the group consisting of: 0.5 hr. or less, 1 hr. or less, 2 hr. or less, 3 hr. or less, 4 hr. or less, 5 hr. or less, or 6 hr. or less. In preferred aspects, rapidly chilling refers to reducing the temperature to a value in the range of about 1° C. to about 4.4° C. (about 34° F. to about 40° F.) within a time period selected from the group consisting of: 0.5 hr. or less, 1 hr. or less, 2 hr. or less, 3 hr. or less.

The phrase “chilled temperature suitable for food-safe storage,” as referred to herein, means a temperature value in the range of about 1° C. to about 5° C. (about 34° F. to about 41° F.), or in a range of about 1° C. to about 4.4° C. (about 34° F. to about 40° F.), or any subranges of the preceding ranges, to provide for increased food quality and safety. In particular aspects, the chilled temperature is about 2° C. (36° F.) to 5° C. (41° F.), with a preferred target of 4° C. (39° F.).

The term “gusset,” as referred to herein, means a piece of material configured (e.g., triangular, rhomboidal, rectangular, etc.) and integrated into a container (e.g., pouch) to strengthen or enlarge (reduce stress or add breadth) a part of it.

The term “single serving” or “single-serving size,” as referred to herein, refers to an individual serving size of about 4 oz to 16 oz, e.g., from 6-8 oz to 10 oz, (113.4 gm to 226.8 gm).

The term “bisphenol A (BPA)-free,” as referred to herein, means BPA was not used in the manufacture of the pouch or fitment material.

In the context of this disclosure, “room temperature” refers to any temperature within a range of temperatures between about 16° C. (approximately 61° F.) and about 25° C. (approximately 77° F.). Commonly, room temperature is between about 20° C. and 22° C. (68° F.-72° F.).

Generally, the term room temperature is used to indicate that no additional energy is expended cooling (e.g., refrigerating) or heating the sample or ambient temperature.

The phrase “Good Manufacturing Practice” or “GMP” with respect to methods and procedures employed in food production refer specifically to the set of methods, protocols and procedures established by the United States Food and Drug Administration (FDA). Similar recommendations and guidelines are promulgated by the World Health Organization. The abbreviation “cGMP” specifically designates those protocols and procedures that are currently approved by the FDA (e.g., under 21 Code of Federal Regulations, parts 210 and 211, available on the world wide web at fda.gov/cder/dmpq). With time cGMP compliant procedures may change. Any methods disclosed herein can be adapted in accordance with new cGMP requirements as mandated by the FDA.

The term “sterilized” with respect to a packaged food product refers to a package food product that has been processed to kill all or substantially all microorganisms in the food product, such as by an ultra-high temperature (UHT) treatment process, by a retort cooking process, or by any method of completely or substantially completely killing the microorganisms in a food product.

A “non-sterilized” food product is a food product that has not been processed to kill substantially all of an amount of microorganisms in the food product, e.g., that has not been processed by a retort cooking step, by a UHT treatment process, or by another sterilization process. Examples of non-sterilized food products include food products that are cooked by a non-retort cooking process and are not subsequently processed by a step that sterilizes the food product.

A “pasteurized” food product is a food product that has been processed by pasteurization, i.e., exposed to elevated temperature for a time that kills microorganisms in the food product. A pasteurized food contains a substantially reduced amount of microorganisms, which will increase the shelf-stability of the food product. The food product may still contain some amount of microorganisms and may not be sterilized.

“Shelf-life” refers to a minimum amount of time during which a food composition of a packaged food product can be stored at a certain temperature condition (e.g., refrigerated or frozen) while experiencing a sufficiently low amount of degradation, microbial growth, or spoilage, for the food composition, in the package, to be transported, stored, and offered for sale, and consumed in the temperature condition. Example packaged food compositions of the present description can be sufficiently stable against spoilage and degradation to have a shelf life of at least 6 weeks after packaging, with refrigerated storage, i.e., refrigerator stable for at least 6 weeks.

### Example 1

### (A Non-Retort Cooked Chunky Macaroni and Cheese (Mac n Cheese) Main Dish was Prepared)

This example shows preparation of a non-retort cooked chunky macaroni and cheese main dish according to the disclosed methods.

Ingredients for this example include chunky pasta (being ⅜″×½″) and cheddar cheese (shredded; 1″×⅛″) together present at about 42-45 wt %, milk, gums, spices, and flavors. These ingredients comprised high amounts of large particulates having a size dimension in a range of: 3 mm to 19 mm (⅛ to ¾ inch) and accounting for a mass percentage in the range of 10% to 90% (e.g., at least 15%, at least 20%, at least 30%, at least 40%, or at least 50%) of the food composition; in a range of 6 mm to 16 mm (¼ to ⅝ inch) and accounting for a mass percentage in the range of 10% to 90% (e.g., at least 15%, at least 20%, at least 30%, at least 40%, or at least 50%) of the food composition; in a range of 10 mm to 13 mm (⅜ to ½ inch) and accounting for a mass percentage in the range of 10% to 90% (e.g., at least 15%, at least 20%, at least 30%, at least 40%, or at least 50%) of the food composition; or any size and/or mass percentage subranges within the preceding ranges.

Pasta was cooked until done and set aside. Cheddar cheese and gums were added to the milk and heated until cheese was fully melted. Dry ingredients such as spices and flavors that were pre-blended were added next. Finally, the pasta was added and the entire mixture cooked for approximately 15 minutes at 195° F. (90.6° C.).

After cooking, non-retort microwavable pouches having a tear-open spout or a fitment with an opening or diameter of about 16 mm to 18 mm were hot-filled (79° C.-91° C. (approx. 175° F.-195° F.)) at less than or equal to about 85 gm/sec (3 oz/sec) with the chunky cooked food and sealed.

The sealed pouches were then quickly chilled to reduce the temperature to a value in the range of about 1° C. to about 4.4° C. (about 34° F. to about 40° F.) within a time period of 6 hr. or less. When they reached the temperature target, they were packed into a master case and stored refrigerated at a temperature value in the range of about 1° C. to about 4.4° C. (about 34° F. to about 40° F.).

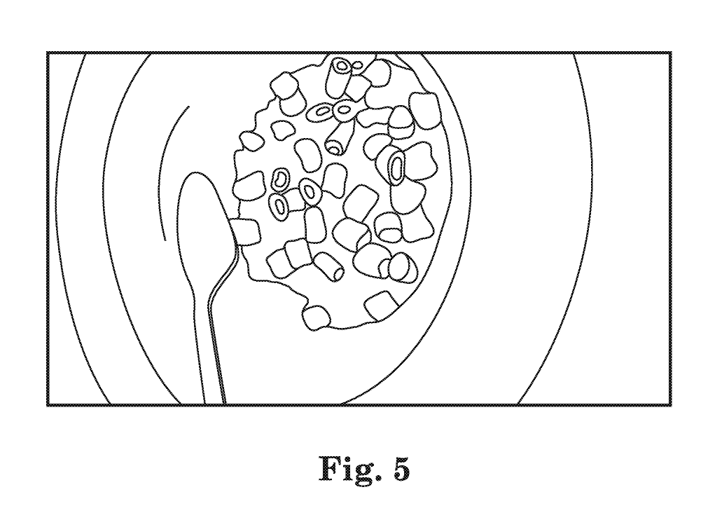

FIG. 5 shows, according to particular aspects of the present invention, an embodiment of Applicant's macaroni and cheese (MNC) chunky food composition, after heating in a pouch and dispensing the MNC from the pouch onto a dish for eating using a spoon.

### Example 2

(Various Non-Retort Cooked Chunky Main Dish Chunky Food Compositions were Prepared)

This example shows that preparation of various non-retort cooked chunky main dish meals was performed according to the disclosed methods.

Foods having chunky food pieces of, for example: chicken, beef, carrots, peas, beans onions, celery, edamame, potatoes, rice, fettuccine, etc., and having a size dimension: in a range of 3 mm to 19 mm (⅛ to ¾ inch) and account for a mass percentage in the range of 10% to 90% (e.g., at least 15%, at least 20%, at least 30%, at least 40%, or at least 50%) of the food composition; in a range of 6 mm to 16 mm (¼ to ⅝ inch) and account for a mass percentage in the range of 10% to 90% (e.g., at least 15%, at least 20%, at least 30%, at least 40%, or at least 50%) of the food composition; in a range of 10 mm to 13 mm (⅜ to ½ inch) and account for a mass percentage in the range of 10% to 90% (e.g., at least 15%, at least 20%, at least 30%, at least 40%, or at least 50%) of the food composition; or any size and/or mass percentage subranges within the preceding ranges, were cooked and processed according to the disclosed methods and likewise retained their chunky texture and organoleptic qualities over an extended refrigerated shelf-life as disclosed herein.

### Example Embodiments

### Example Embodiment 1

A hand-dispensable non-retort cooked and packaged chunky food having improved organoleptic and nutritional qualities, comprising:

a non-retort cooked chunky food composition having sized chunky food pieces that account for a mass percentage in the range of 5% to 95% of the food composition to provide a chunky textured food composition; packaged within a hand-holdable, non-retort, microwaveable, self-venting flexible-film pouch having a dispensing portion sized and configured to provide for substantially unimpeded flow of the sized chunky food composition during hand-mediated dispensing thereof from the pouch, to provide a hand-dispensable non-retort cooked and packaged chunky food.

### Example Embodiment 2

The packaged chunky food of Example Embodiment 1, wherein the shelf-life thereof is a time period selected from the group consisting of: at least 7, 14, 30, or 60 days, at least 90 days, at least 120 days, at least 150 days, at least 180 days, at least 230 days, at least 360 days, any subranges within and between any of the preceding periods, and greater periods, in each case at a storage temperature value in a range of about 1° C. to about 4.4° C. (about 34° F. to about 40° F.), or frozen.

### Example Embodiment 3

The packaged chunky food of Example Embodiment 1, wherein the pouch and the dispending portion are configured to provide for directed flow of the non-retort cooked packaged chunky food during hand-mediated dispensing thereof.

### Example Embodiment 4

The packaged chunky food of Example Embodiment 1, wherein the pouch is internally shaped to provide for directed flow of the non-retort cooked packaged chunky food during hand-mediated dispensing thereof.

### Example Embodiment 5

The packaged chunky food of Example Embodiment 1, wherein the chunky food pieces have a size dimension in a range of 3 mm to 19 mm (⅛ to ¾ inch) and account for a mass percentage in the range of 10% to 90% of the food composition.

### Example Embodiment 6

The packaged chunky food of Example Embodiment 5, wherein the chunky food pieces have a size dimension in a range of 3 mm to 19 mm (⅛ to ¾ inch) and account for a mass percentage of at least 15%, at least 20%, at least 30%, at least 40%, or at least 50% of the food composition.

### Example Embodiment 7

The packaged chunky food of Example Embodiment 1, wherein the chunky food pieces have a size dimension in a range of 6 mm to 16 mm (¼ to ⅝ inch) and account for a mass percentage in the range of 10% to 90% of the food composition.

### Example Embodiment 8

The packaged chunky food of Example Embodiment 7, wherein the chunky food pieces have a size dimension in a range of 6 mm to 16 mm (¼ to ⅝ inch) and account for a mass percentage of at least 15%, at least 20%, at least 30%, at least 40%, or at least 50% of the food composition.

### Example Embodiment 9

The packaged chunky food of Example Embodiment 1, wherein the chunky food pieces have a size dimension in a range of 10 mm to 13 mm (⅜ to ½ inch) and account for a mass percentage in the range of 10% to 90% of the food composition.

### Example Embodiment 10

The packaged chunky food of Example Embodiment 9, wherein the chunky food pieces have a size dimension in a range of 10 mm to 13 mm (⅜ to ½ inch) and account for a mass percentage of at least 15%, at least 20%, at least 30%, at least 40%, or at least 50% of the food composition.

### Example Embodiment 11

The packaged chunky food of Example Embodiment 1, wherein the dispensing portion comprises a tear-open spout or a fitment, to provide an opening or diameter in the range of 14 mm to 26 mm.

### Example Embodiment 12

The packaged chunky food of Example Embodiment 11, wherein the dispensing portion comprises a tear-open spout or a fitment, to provide an opening or diameter in the range of 16 mm to 20 mm or in the range of 16 mm to 18 mm.

### Example Embodiment 13

The packaged chunky food of Example Embodiment 1, wherein the food composition has been cooked under non-retort conditions at a temperature of less than 93.3° C. (less than 200° F.) to substantially reduce heat-induced degradation of at least one of flavor, color, texture, aroma, or nutrients.

### Example Embodiment 14

The packaged chunky food of Example Embodiment 13, wherein the food composition has been cooked under non-retort conditions at a temperature in a range of 74° C.-90.6° C. (165° F.-195° F.) to substantially reduce heat-induced degradation of at least one of flavor, color, texture, aroma, or nutrients.

### Example Embodiment 15

The packaged chunky food of Example Embodiment 1, wherein the dispensing portion comprises a dispensing opening located at a top, bottom, corner, edge, or center position of the pouch to facilitate dispensing of the food composition from the pouch.

### Example Embodiment 16

The packaged chunky food of Example Embodiment 1, wherein the dispensing portion is resealable with a resealable closure or cap sized to meet anti-choking hazard standards.

### Example Embodiment 17

The packaged chunky food of Example Embodiment 16, wherein the dispensing portion comprises a fitment with an over-sized closure having one or more gripping features or points to provide a mechanical advantage to facilitate opening of the closure by force applied by a user.

### Example Embodiment 18

The packaged chunky food of Example Embodiment 1, wherein the pouch is laser perforated to provide for self-venting during microwaving without a need for opening of the pouch or mixing of the food composition within the pouch.

### Example Embodiment 19

The packaged chunky food of Example Embodiment 1, wherein the pouch and dispensing portion are configured to provide a stand-up pouch, wherein the dispensing portion comprises a dispensing opening located at a top center position of the pouch to facilitate hand-mediated dispensing of the food composition from the pouch.

### Example Embodiment 20

The packaged chunky food of Example Embodiment 1, wherein the pouch comprises a gusset.

### Example Embodiment 21

The packaged chunky food of Example Embodiment 1, wherein the pouch is a single-serving size or multiple-serving size.

### Example Embodiment 22

The packaged chunky food of Example Embodiment 1, wherein the pouch and fitment are bisphenol A (BPA)-free.

### Example Embodiment 23

The packaged chunky food of Example Embodiment 1, wherein the dispensable non-retort packaged chunky food comprises no added preservatives, or comprises only naturally-occurring preservatives, or safe food preservatives.

### Example Embodiment 24

The packaged chunky food of Example Embodiment 1, wherein the food composition is refrigerated at a temperature value in a range of about 1° C. to about 4.4° C. (about 34° F. to about 40° F.) or frozen.

### Example Embodiment 25

The packaged chunky food of Example Embodiment 1, wherein a full caloric density of main meal course/entree is provided in the pouch.

### Example Embodiment 26

A method for making a hand-dispensable non-retort cooked and packaged chunky food having improved organoleptic and nutritional qualities, comprising: cooking a chunky food under non-retort conditions at a cooking temperature(s) and for a time sufficient to provide a non-retort cooked chunky food composition having sized chunky food pieces that account for a mass percentage in the range of 5% to 95% of the food composition, in a heated state; and transferring, at a transferring temperature and at a transfer rate, the heated non-retort cooked sized chunky textured food composition into a hand-holdable, non-retort, microwaveable, self-venting flexible-film pouch having a dispensing portion sized and configured to provide for substantially unimpeded flow of the cooked sized chunky textured food composition during filling and hand-mediated dispensing thereof from the pouch, to provide a hand-dispensable non-retort cooked and packaged chunky food, wherein the transferring temperature and the transfer rate are sufficient to provide for bottom-up filling of the pouch without air pockets, and substantial retention of the sized chunky texture of the cooked food composition.

### Example Embodiment 27

The method of Example Embodiment 26, further comprising, after transferring, rapidly chilling the dispensable non-retort packaged chunky food to a chilled temperature suitable for food-safe storage, to provide a chilled, food-grade, dispensable non-retort packaged chunky food.

### Example Embodiment 28

The method of Example Embodiment 26 or 27, wherein the shelf-life of the hand-dispensable non-retort cooked and packaged chunky food is a time period selected from the group consisting of: at least 7, 14, 30, or 60 days, at least 90 days, at least 120 days, at least 180 days, at least 230 days, at least 360 days, any subranges within and between any of the preceding periods, and greater periods, in each case at a storage temperature value in a range of about 1° C. to about 4.4° C. (about 3° F. to about 40° F.) or frozen.

### Example Embodiment 29

The method of Example Embodiment 26, wherein, prior to cooking, the chunky food is sized to provide for substantially unimpeded passage through an opening or diameter in the range of 14 mm to 26 mm.

### Example Embodiment 30

The method of Example Embodiment 29, wherein, prior to cooking, the chunky food is sized to provide for substantially unimpeded passage through an opening or diameter in the range of 16 to 20 mm or of 16 mm to 18 mm.

### Example Embodiment 31

The method of Example Embodiment 27, wherein rapidly chilling comprises reducing the temperature to a value in the range of about 1° C. to about 4.4° C. (about 34° F. to about 40° F.) within a time period selected from the group consisting of: 0.5 hours or less, 1 hour or less, 2 hours or less, 3 hours or less, 4 hours or less, 5 hours or less, or 6 hours or less, to provide for increased food quality and safety.

### Example Embodiment 32

The method of Example Embodiment 26, wherein transferring is performed at a transfer rate selected from the group consisting of: less than or equal to 28.4 gm/sec (1 oz/sec), less than or equal to 56.7 gm/sec (2 oz/sec), less than or equal to 85 gm/sec (3 oz/sec), less than or equal to 113.4 gm/sec (4 oz/sec), less than or equal to 141.8 gm/sec (5 oz/sec), less than or equal to 170.1 gm/sec (6 oz/sec), and less than or equal to 283.5 gm/sec (10 oz/sec), or at a greater rate.

### Example Embodiment 33

The method of Example Embodiment 26, wherein the transferring temperature is a temperature in a range of 79° C.-91° C. (approx. 175° F.-195° F.).

### Example Embodiment 34

The method of Example Embodiment 26, wherein the cooked chunky food pieces have a size dimension in a range of 3 mm to 19 mm (⅛ to ¾ inch) and account for a mass percentage in the range of 10% to 90% of the food composition.

### Example Embodiment 35

The method of Example Embodiment 34, wherein the cooked chunky food pieces have a size dimension in a range of 3 mm to 19 mm (⅛ to ¾ inch) and account for a mass percentage of at least 15%, at least 20%, at least 30%, at least 40%, or at least 50% of the food composition.

### Example Embodiment 36

The method of Example Embodiment 26, wherein the cooked chunky food pieces have a size dimension in a range of 6 mm to 16 mm (¼ to ⅝ inch) and account for a mass percentage in the range of 10% to 90% of the food composition.

### Example Embodiment 37

The method of Example Embodiment 36, wherein the cooked chunky food pieces have a size dimension in a range of 6 mm to 16 mm (¼ to ⅝ inch) and account for a mass percentage of at least 15%, at least 20%, at least 30%, at least 40%, or at least 50% of the food composition.

### Example Embodiment 38

The method of Example Embodiment 26, wherein the cooked chunky food pieces have a size dimension in a range of 10 mm to 13 mm (⅜ to ½ inch) and account for mass percentage in the range of 10% to 90% of the food composition.

### Example Embodiment 39

The method of Example Embodiment 38, wherein the cooked chunky food pieces have a size dimension in a range of 10 mm to 13 mm (⅜ to ½ inch) and account for a mass percentage of at least 15%, at least 20%, at least 30%, at least 40%, or at least 50% of the food composition.

### Example Embodiment 40

The method of Example Embodiment 26, wherein the dispensing portion comprises a tear-open spout or a fitment, to provide an opening or diameter in the range of 14 mm to 26 mm.

### Example Embodiment 41

The method of Example Embodiment 40, wherein the dispensing portion comprises a tear-open spout or a fitment, to provide an opening or diameter in the range of 16 mm to 20 mm, or in the range of 16 mm to 18 mm.

### Example Embodiment 42

The method Example Embodiment 26, wherein the food composition has been cooked under non-retort conditions at a temperature of less than 93.3° C. (less than 200° F.) to substantially reduce heat-induced degradation of at least one of flavor, color, texture, aroma, or nutrients.

### Example Embodiment 43

The method Example Embodiment 42, wherein the food composition has been cooked under non-retort conditions at a temperature in a range of 74° C.-90.6° C. (165° F.-195° F.) to substantially reduce heat-induced degradation of at least one of flavor, color, texture, aroma, or nutrients.

### Example Embodiment 44

The method Example Embodiment 26, wherein the dispensing portion comprises a dispensing opening located at a top, bottom, corner, or center position of the pouch to facilitate dispensing of the food composition from the pouch.

### Example Embodiment 45

The method Example Embodiment 26, wherein the dispensing portion is resealable with a resealable closure or cap sized to meet anti-choking hazard standards.

### Example Embodiment 46

The method Example Embodiment 45, wherein the dispensing portion comprises a fitment with an over-sized closure having one or more gripping features or points to provide a mechanical advantage to facilitate opening of the closure by force applied by a user.

### Example Embodiment 47

The method Example Embodiment 26, wherein the pouch is laser perforated to provide for self-venting during microwaving without a need for opening of the pouch or mixing of the food composition within the pouch.

### Example Embodiment 48

The method Example Embodiment 26, wherein the pouch and dispensing portion are configured to provide a stand-up pouch, wherein the dispensing portion comprises a dispensing opening located at a top center position of the pouch to facilitate dispensing of the food composition from the pouch.

### Example Embodiment 49

The method Example Embodiment 26, wherein the pouch comprises a gusset.

### Example Embodiment 50

The method Example Embodiment 26, wherein the pouch is a single-serving (e.g., 8 ounces; 226.8 gm) size, or multiple-serving size.

### Example Embodiment 51

The method Example Embodiment 26, wherein the pouch and fitment are bisphenol A (BPA)-free.

### Example Embodiment 52

The method Example Embodiment 26, wherein the hand-dispensable non-retort packaged chunky food comprises no added preservatives, or comprises only naturally occurring preservatives, or safe food preservatives.

### Example Embodiment 53

The method of Example Embodiment 27, further comprising storing the chilled, sterile, dispensable non-retort packaged chunky food at a storage temperature suitable for food-safe storage.

### Example Embodiment 54

The method of Example Embodiment 53, wherein the chilled temperature and the storage temperature are the same, or substantially the same.

### Example Embodiment 55

The method of Example Embodiment 53, wherein the storage temperature is a value in the range of about 1° C. to about 4.4° C. (about 34° F. to about 40° F.) or freezing.

### Example Embodiment 56

The method of Example Embodiment 26, wherein the pouch and dispensing portion are configured to provide for directed flow of the non-retort cooked packaged chunky food during hand-mediated dispensing thereof.

### Example Embodiment 57

The method of Example Embodiment 26, wherein the pouch is internally shaped to provide for directed flow of the non-retort cooked packaged chunky food during hand-mediated dispensing thereof.

### Example Embodiment 58

The method of Example Embodiment 26, further comprising adding of a preservative agent to the chunky food.

### Example Embodiment 59

The method of Example Embodiment 58, wherein the preservative is added prior to or during filling of the pouch.

### Example Embodiment 60

A hand-holdable, non-retort food-dispensing pouch for chunky foods, comprising a hand-holdable, non-retort, microwaveable, self-venting flexible-film pouch having a dispensing portion sized and configured to provide for substantially unimpeded flow of a cooked chunky food composition having sized chunky food pieces that account for a mass percentage in the range of 5% to 100% of the food composition during hand-mediated dispensing thereof from the pouch.

### Example Embodiment 61

The hand-holdable, non-retort food-dispensing pouch of Example Embodiment 60, wherein the pouch and the dispending portion are configured to provide for directed flow of the non-retort cooked packaged chunky food during hand-mediated dispensing thereof.

### Example Embodiment 62

The hand-holdable, non-retort food-dispensing pouch of Example Embodiment 61, wherein the pouch is internally shaped to provide for directed flow of the non-retort cooked packaged chunky food during hand-mediated dispensing thereof.

### Example Embodiment 63

The hand-holdable, non-retort food-dispensing pouch of Example Embodiment 60, wherein the dispensing portion is sized and configured to provide for substantially unimpeded flow of a chunky food composition having chunky food pieces with a size dimension in a range of 3 mm to 19 mm (⅛ to ¾ inch) that account for a mass percentage in the range of 10% to 90% of the food composition.

### Example Embodiment 64

The hand-holdable, non-retort food-dispensing pouch of Example Embodiment 63, wherein the dispensing portion is sized and configured to provide for substantially unimpeded flow of a chunky food composition having chunky food pieces with a size dimension in a range of 3 mm to 19 mm (⅛ to ¾ inch) that account for a mass percentage of at least 15%, at least 20%, at least 30%, at least 40%, or at least 50% of the food composition.

### Example Embodiment 65

The hand-holdable, non-retort food-dispensing pouch of Example Embodiment 60, wherein the dispensing portion is sized and configured to provide for substantially unimpeded flow of a chunky food composition having chunky food pieces with a size dimension in a range of 6 mm to 16 mm (¼ to ⅝ inch) that account for a mass percentage in the range of 10% to 90% of the food composition.

### Example Embodiment 66

The hand-holdable, non-retort food-dispensing pouch of Example Embodiment 65, wherein the dispensing fitment is sized and configured to provide for substantially unimpeded flow of a chunky food composition having food pieces with a size dimension in a range of 6 mm to 16 mm (¼ to ⅝ inch) that account for a mass percentage of at least 15%, at least 20%, at least 30%, at least 40% or at least 50% of the food composition.

### Example Embodiment 67

The hand-holdable, non-retort food-dispensing pouch of Example Embodiment 60, wherein the dispensing portion is sized and configured to provide for substantially unimpeded flow of a chunky food composition having chunky food pieces with a size dimension in a range of 10 mm to 13 mm (⅜ to ½ inch) that account for a mass percentage of at least 15%, at least 20%, at least 30%, at least 40%, or at least 50% of the food composition.

### Example Embodiment 68

The hand-holdable, non-retort food-dispensing pouch of Example Embodiment 67, wherein the dispensing portion is sized and configured to provide for substantially unimpeded flow of a chunky food composition having chunky food pieces with a size dimension in a range of 10 mm to 13 mm (⅜ to ½ inch) that account for a mass percentage of at least 15%, at least 20%, at least 30%, at least 40%, or at least 50% of the food composition.

### Example Embodiment 69

The hand-holdable, non-retort food-dispensing pouch of Example Embodiment 60, wherein the dispensing portion comprises a tear-open spout or a fitment, to provide an opening or diameter in the range of 14 mm to 26 mm.

### Example Embodiment 70

The hand-holdable, non-retort food-dispensing pouch of Example Embodiment 69, wherein the dispensing portion comprises a tear-open spout or a fitment, to provide an opening or diameter in the range of 16 mm to 20 mm, or of 16 mm to 18 mm.

### Example Embodiment 71

The hand-holdable, non-retort food-dispensing pouch of Example Embodiment 60, wherein the dispensing portion comprises a dispensing opening located at a top, bottom, corner, edge, or center position of the pouch to facilitate dispensing of the food composition from the pouch.

### Example Embodiment 72

The hand-holdable, non-retort food-dispensing pouch of Example Embodiment 60, wherein the dispensing portion is resealable with a resealable closure or cap sized to meet anti-choking hazard standards.

### Example Embodiment 73

The hand-holdable, non-retort food-dispensing pouch of Example Embodiment 72, wherein the dispensing portion comprises a fitment with an over-sized closure having one or more gripping features or points to provide a mechanical advantage to facilitate opening of the closure by force applied by a user.

### Example Embodiment 74

The hand-holdable, non-retort food-dispensing pouch of Example Embodiment 60, wherein the pouch is laser perforated or has a rupturable seal/vent to provide for self-venting during microwaving without a need for opening of the pouch or mixing of the food composition within the pouch.

### Example Embodiment 75

The hand-holdable, non-retort food-dispensing pouch of Example Embodiment 60, wherein the pouch and dispensing portion are configured to provide a stand-up pouch, and wherein the dispensing portion comprises a dispensing opening located at a top center position of the pouch to facilitate dispensing of the food composition from the pouch.

### Example Embodiment 76

The hand-holdable, non-retort food-dispensing pouch of Example Embodiment 60, wherein the pouch comprises a gusset.

### Example Embodiment 77

The hand-holdable, non-retort food-dispensing pouch of Example Embodiment 60, wherein the pouch is a single-serving size (e.g., 8 ounces).

### Example Embodiment 78

The hand-holdable, non-retort food-dispensing pouch of Example Embodiment 60, wherein the pouch and fitment are bisphenol A (BPA)-free.

### Example Embodiment 79

The hand-holdable, non-retort food-dispensing pouch of Example Embodiment 60, wherein the pouch comprises one or more flexible film layers.

### Example Embodiment 80

The hand-holdable, non-retort food-dispensing pouch of Example Embodiment 60, wherein the pouch comprises no foil or metallic-based layers that would preclude microwaving.

### Example Embodiment 81

The hand-holdable, non-retort food-dispensing pouch of Example Embodiment 60, wherein the dispensing portion is made from non-electrically conductive materials and/or non-heat conductive materials.

### Example Embodiment 82

The hand-holdable, non-retort food-dispensing pouch of Example Embodiment 60, wherein the pouch comprises a cool-touch area at or near the top of the pouch and/or near the dispensing portion to enable, in use of the pouch, grasping after microwaving.

1. A packaged food product comprising:
a cooked, chunky food composition in a flexible package,
the package comprising a dispensing portion adapted to allow hand-dispensing of the food product to a user's mouth.

2. A packaged food product of claim 1 wherein the chunky food composition is non-retort cooked.

3. A packaged food product of claim 1 wherein the chunky food composition is retort cooked or sterilized.

4. A packaged food product of claim 1 comprising a closed dispensing portion that can be opened, and the food composition can be caused to flow from the flexible package and through the open dispensing portion by hand.

5. (canceled)

6. (canceled)

7. A packaged food product of claim 1 wherein the packaged food product is refrigerated.

8. (canceled)

9. A packaged food product of claim 1 wherein the flexible package is microwaveable.

10. A packaged food product of claim 9 wherein the microwaveable flexible package is self-venting.

11. A packaged food product of claim 1 wherein the flexible package includes laser self-venting perforations.

12. A packaged food product of claim 1 wherein the food composition is a chunky textured food composition and the package is a hand-holdable, microwaveable, self-venting flexible package having a dispensing portion that allows for substantially unimpeded flow of the food composition during hand-mediated dispensing thereof.

13. A packaged food product of claim 1 wherein the food particles have a dimension in a range of from 6 to 19 millimeters, and the food composition contains from 5 to 90 percent of the food particles.

14. A packaged food product of claim 1 wherein the food composition has been cooked under non-retort conditions at a temperature less than 200 degrees Fahrenheit, and is refrigerator stable for at least 7 days.

15. A packaged food product of claim 1 wherein the package and dispensing portion are configured to provide a stand-up pouch, and wherein the dispensing portion comprises a dispensing opening located at a top center.

16. A packaged food product of claim 1 wherein the flexible film does not include a metallic-based layer.

17. A packaged food product of claim 1 wherein the package contains from about 4 to 24 ounces of the cooked food composition.

18. (canceled)

19. (canceled)

20. A method of consuming a packaged food product of claim 1, the method comprising dispensing the food composition directly from the package, through the dispensing portion, to a user's mouth.

21. A method of preparing a packaged food product of claim 1, the method comprising heating the package and the cooked, chunky food composition and dispensing the food composition directly from the package, through the dispensing portion, to a user's mouth.

22. (canceled)

23. A method of claim 20 comprising hand-dispensing the chunky food composition from the package by applying pressure to sides of the flexible package to cause the chunky food composition to pass through the dispensing portion.

24. A method of preparing a packaged food product comprising a cooked, chunky food composition in a flexible package that includes a dispensing portion adapted to allow hand-dispensing of the food composition to a user's mouth, the method comprising:
cooking the chunky food composition, and
placing the cooked food composition in the flexible package.

25. A method of claim 24 wherein the cooked chunky food composition is cooked by a non-retort cooking step while outside of the package.

26. A method of claim 25 comprising, after placing the cooked food composition in the package, rapidly chilling the packaged cooked food composition by reducing a temperature of the cooked food composition to a temperature in a range of from 34 to about 40 degrees Fahrenheit, within 0.5 hours.
